(19) United States
(12) Patent Application Publication
(10) Pub. No.: US 2003/0219042 A1
(43) Pub. Date: Nov. 27, 2003

(54) Time divison multiplexing and transport method, apparatus and system

(76) Inventor: Akira Tosa, Tokyo (JP)

Correspondence Address: McGinn & Gibb, Suite 200, 8321 Old Courthouse Road, Vienna, VA, 22182-3817, US

(21) Appl. No.: 10/275,573

(22) PCT Filed: May 23, 2002
(86) PCT No.: PCT/JP02/05001

(51) Int. Cl. H04J 3/02

(52) U.S. Cl. 370/540

(57) ABSTRACT

Multi-channel Ethernet port data, each including communication data and control data, are time-division multiplexed (TDM) into a SONET/SDH frame for transport. Ethernet port data for each of a plurality of channels is sequentially read in units of a byte that is one of communication data and control data, and a TDM frame containing one byte for each of the plurality of channels is sequentially generated. A frame of a digital synchronous network is generated by containing the plurality of TDM frames in a payload portion thereof and is transported through the SONET/SDH network.

### TECHNICAL FIELD

The present invention relates to techniques of time-division multiplexing (TDM) and transport of signals of a plurality of Ethernets (Registered Trademark, the same with below), and in particular to a system, method and apparatus of multiplexing a plurality of TDM frames into a digital synchronous network frame for transport.

### BACKGROUND ART

Recently, with remarkable increase in data communication traffic, techniques of economically and efficiently transmitting such sharply growing traffic become increasingly important. Such a transmission technique has been proposed, which employs a synchronous optical network such as SONET/SDH to connect gigabit Ethernet LANs.

For example, Japanese Patent Publication No. P2001-45069A discloses a transmission technique of time-division multiplexing a plurality of 1-gigabit Ethernet signals that are obtained respectively by converting 1.25-gigabit Ethernet signals according to 8B10B encoding conversion.

However, the above-mentioned gigabit Ethernet time-division multiplexing technique is premised on gigabit Ethernet signals, not a technique of multiplexing existing 10/100 Mbps Ethernet signals. In addition, it is necessary to convert a plurality of 1.25-gigabit Ethernet signals to 1-gigabit Ethernet signals when multiplexing them into an optical path signal, and further, at a receiving side, to demultiplex the optical path signal into a plurality of gigabit Ethernet signals, which are inversely converted from 1-gigabit to 1.25-gigabit by the 8B10B encoding conversion.

As described above, the conventional time-division multiplexing technique has a complicated system structure and further cannot time-division multiplex 10/100 Mbps Ethernet signals to transparently transport.

An object of the present invention is to provide time-division multiplexing and transport system, method and apparatus, which transparently transmit a plurality of transmission signals through a digital synchronous network according to time-division multiplexing.

Another object of the present invention is to provide time-division multiplexing and transport system, method and apparatus, which has a simplified structure allowing time-division multiplexing of 10/100 Mbps Ethernet signals for transparent transport.

### DISCLOSURE OF INVENTION

According to a first aspect of the present invention, a time-division multiplexing and transport apparatus is an apparatus for time-division multiplexing (TDM) of multi-channel transmission signals into a frame of a digital synchronous network for transport, each of the multi-channel transmission signals including communication data and control data, and the apparatus is characterized by TDM frame generating means for sequentially generating a plurality of TDM frames by sequentially reading a transmission signal for each of a plurality of channels in units of a data block having a predetermined length, the data block being one of the communication data and the control data, to contain one data block for each channel in a TDM frame; and synchronous network frame generating means for generating the frame of the digital synchronous network by containing the plurality of TDM frames in a payload portion thereof.

By sequentially reading a transmission signal for each of a plurality of channels in units of a data block having a predetermined length and being one of the communication data and the control data and sequentially generating a TDM frame that contains one data block for each channel to contain a plurality of TDM frames in a payload portion thereof, transmission signals to be exchanged can be transparently transported through the digital synchronous network. In addition, there is no need of special data conversion and packet buffer, which would be needed in the prior art when Ethernet packets are time-division multiplexed, resulting in simplified configuration.

According to a second aspect of the present invention, a time-division multiplexing and transport apparatus is an Ethernet signal time-division multiplexing and transport apparatus for time-division multiplexing (TDM) of a plurality of Ethernet signals, and the apparatus is characterized by multi-channel physical layer devices each connected to a plurality of Ethernets; TDM assembling means for sequentially generating a TDM frame by inputting each of multi-channel signals in units of a byte to contain a plurality of TDM frames in a payload portion of a frame of a digital synchronous network; and synchronous transmitting means for transmitting the frame of the digital synchronous network to the synchronous network, the frame containing the TDM frames with an overhead portion added to the payload portion.

Preferably, it is characterized in that each of the multi-channel signals includes Ethernet communication data and line control data, and the byte included in each TDM frame is one of the communication data and the control data. In addition, it is preferable that the TDM frame has a control flag for each of a plurality of channels, wherein each control flag indicates which one of communication data and control data the byte of a corresponding channel signal is.

By configuring as above described, 10/100 Mbps Ethernet signals can be transparently transported with a simplified structure through the digital synchronous network.

### BRIEF DESCRIPTION OF DRAWINGS

FIG. 1 is a schematic block diagram of a time-division multiplexing and transport system according to the present invention,

FIG. 2(A) is a format diagram showing a frame structure of STM-16, which is generated by a TDM assembling section, FIG. 2(B) is a format diagram of a TDM frame that is multiplexed into a payload region of the frame structure of STM-16, and FIG. 2(C) is a format diagram of a control field in the TDM frame,

FIG. 3(A) is a diagram showing an example of relationship between byte control flag and Ethernet port data, FIG. 3(B) is a schematic diagram showing sequentially arranged Ethernet port data that are time-division multiplexed into a payload, and FIG. 3(C) is a diagram showing an example of bit definition of control data,

FIG. 4 is a block diagram showing a functional structure of an embodiment of the present invention, and

FIG. 5 is a schematic diagram for specifically explaining assembling/disassembling operations of a time-division multiplexing method according to the present invention.

### BEST MODE FOR CARRYING OUT THE INVENTION

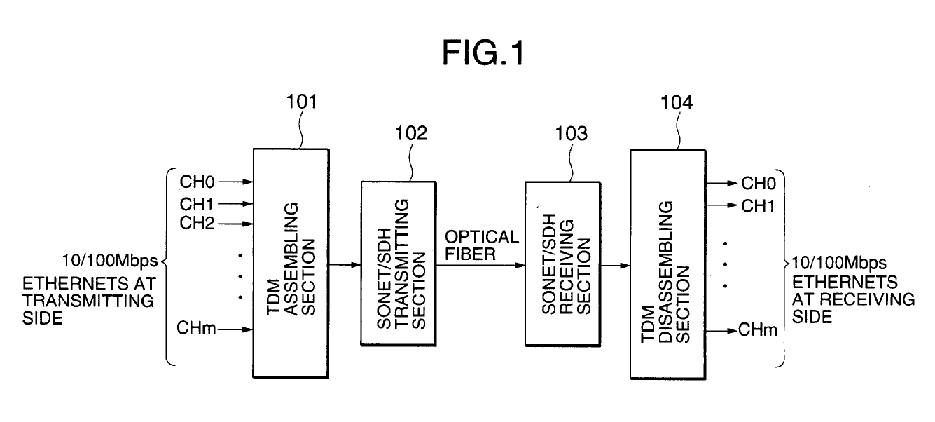

FIG. 1 is a schematic block diagram of a time-division multiplexing and transport system according to the present invention. At a transmitting side, a TDM assembling section 101 and a SONET/SDH transmitting section 102 are provided and, at a receiving side, a SONET/SDH receiving section 103 and a TDM disassembling section 104 are provided.

The TDM assembling section 101 has Ethernet ports each corresponding to m-channel (CHl-CHm) 10/100 Mbps Ethernets, from which m-channel 10/100 Mbps Ethernet signals are received, respectively.

As described later, the m 10/100 Mbps Ethernet signals are time-division multiplexed into the payload portion to assemble a frame corresponding to predetermined SONET/SDH service. The SONET/SDH transmitting section 102 inputs this frame and generates a predetermined SONET/SDH frame to send it to an optical fiber.

The SONET/SDH receiving section 103 receives an optical signal and the TDM disassembling section 104 disassembles the TDM frames time-division multiplexed into the payload portion to original m-channel 10/100 Mbps Ethernet signals.

Next, as an example of the time-division multiplexing transmission according to the present invention, the case where 20-channel (CH0-CH19) 10/100 Mbps Ethernet signals are multiplexed into a SONET/SDH frame of 2.48832 Gbps (OC-48/STM-16) for transport will be described.

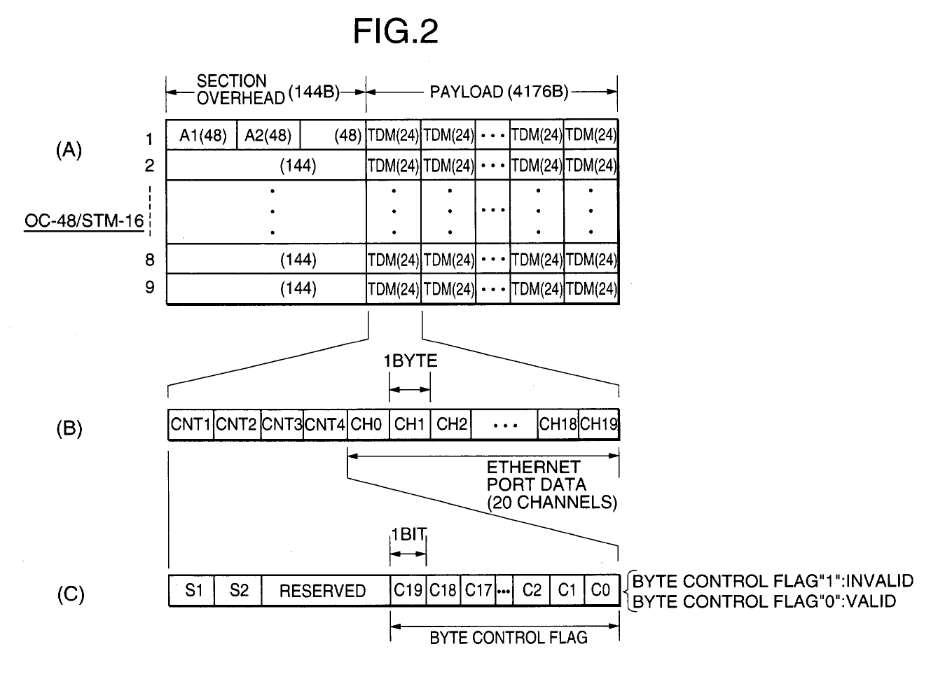

FIG. 2(A) is a format diagram showing a frame structure of STM-16, which is generated by a TDM assembling section, FIG. 2(B) is a format diagram of a TDM frame that is multiplexed into a payload region of the frame structure of STM-16, and FIG. 2(C) is a format diagram of a control field in the TDM frame.

As shown in FIG. 2(A), an STM-16 frame generated by the TDM assembling section 101 is a standard frame composed of a section overhead and a payload. Here, since private network operations are assumed, only a frame sync bit pattern (A1, A2) is inserted in the section overhead. A payload has 1566 slots of TDM frames each of which has 24 bytes per slot, multiplexed to be transported.

As shown in FIG. 2(B), a TDM frame of 24 bytes is composed of 4-byte control data (CNT1-CNT4) and 20-byte Ethernet port data (CH0-CH19). The 20-byte Ethernet port data consists of 20 bytes each corresponding to 20 channels CH0-CH19. in other words, the Ethernet channels CH0-CH19 as shown in FIG. 1 correspond to the Ethernet port data CH0-CH19 of FIG. 2(B), respectively.

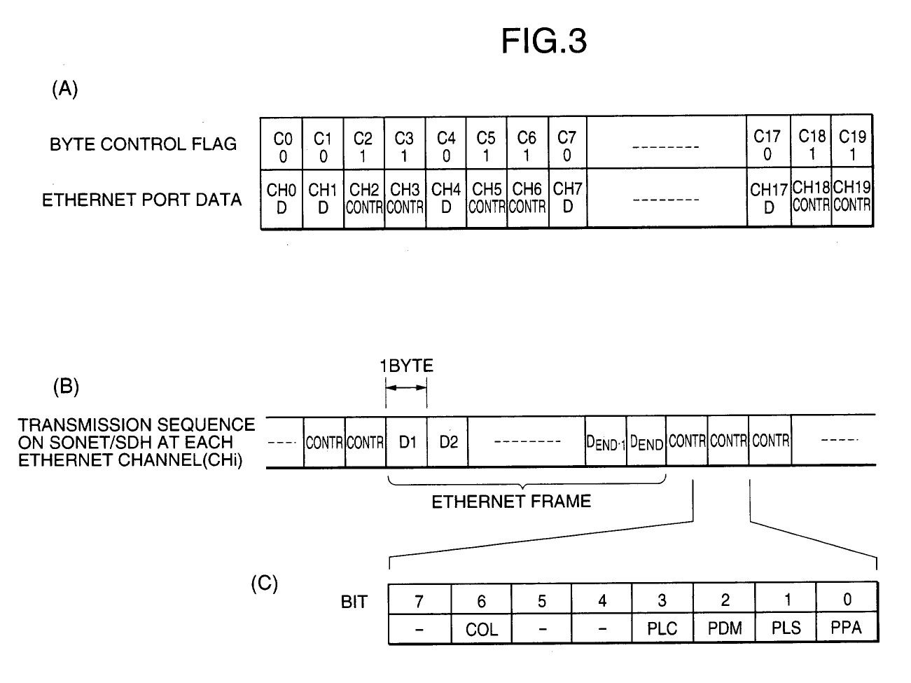

In FIG. 2(C), the last 20 bits of the 4-byte control data CNT1-CNT4 are defined as byte control flags C0-C19. The respective byte control flags C0-C19 correspond to the following Ethernet port data CH0-CH19, and each byte control flag indicates that a corresponding Ethernet port data is control data or communication data depending on whether the byte control flag is “1” (invalid) or “0” (valid). Here, the control data is a signal for transmitting the line status or the like of the corresponding Ethernet and the communication data is a frame signal of the corresponding Ethernet. A concrete example will be shown in FIG. 3(A).

FIG. 3(A) is a diagram showing an example of relationship between byte control flag and Ethernet port data. When the byte control flag is “1” (invalid), the Ethernet port data of a corresponding channel is Ethernet control data (Contr). Here, Ethernet signals of the channels CH2, CH3, CH5-CH6 and so on are control data. When the byte control flag is “0” (valid), the Ethernet port data of a corresponding channel is Ethernet frame data (D). Here, Ethernet signals of the channels CH0, CH1, CH4, CH7 and so on are communication data.

FIG. 3(B) is a schematic diagram showing sequentially arranged Ethernet port data that are time-division multiplexed into a payload. In the example as shown in FIG. 3(B), at a channel CHi, communication data D1-D_{END} corresponding to the Ethernet frame are transmitted before control data (Contr).

In this case, the Ethernet frame is sequentially transmitted byte by byte such that the Ethernet port data corresponding to the channel CHi of a TDM frame is communication data D1, the Ethernet port data corresponding to the same channel CHi of the subsequent TDM frame is communication data D2, and so on. When the last communication data D_{END} of the relevant Ethernet frame has been transmitted, the Ethernet port data corresponding to the same channel CHi of the TDM frame following the last communication data D_{END} becomes control data and thereafter the control data is sequentially transmitted in the similar manner until the next Ethernet frame.

FIG. 3(C) is a diagram showing an example of bit definition of control data. Here, in 1-byte control data (Contr), the 6th bit indicates the presence or absence of collision detection (COL) in Ethernet block, the 3rd bit indicates the link status (PLC) of its own channel PHY, the 2nd bit indicates duplex mode (PDM) of the own channel physical layer device PHY, the 1st bit indicates the line speed (PLS) of the own channel physical layer device PHY, and the 0th bit indicates the PAUSE propagation admission (PPA) in an auto negotiation mode.

(TDM Assembling/Disassembling Apparatus)

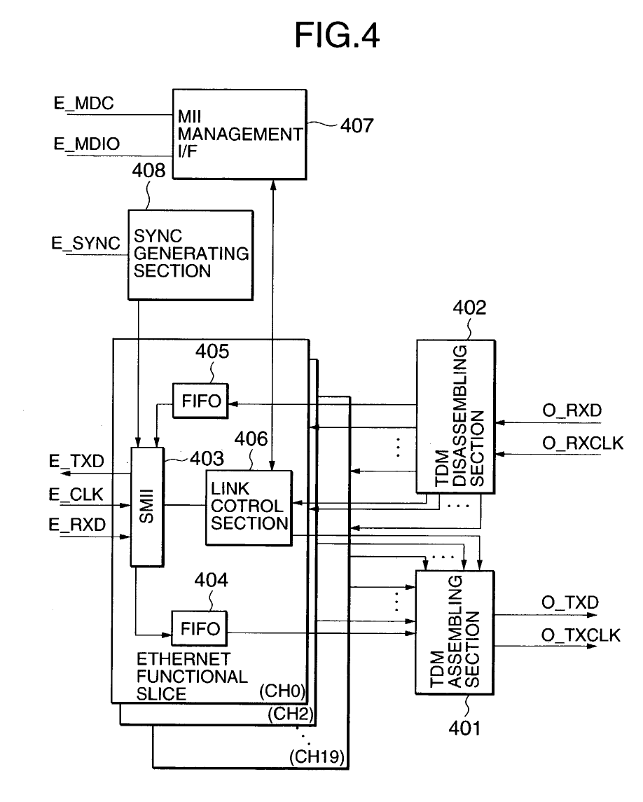

FIG. 4 is a block diagram showing a functional structure of an embodiment of the present invention. The SONET/SDH time-division multiplexing and transmitting apparatus according the present embodiment is provided with 20 Ethernet functional slices (CH0-CH19) each corresponding to the 20-channel (CH0-CH19) 10/100 Mbps Ethernets, and each of the 20 Ethernet functional slices is connected to the Ethernet physical layer device (not shown) for each channel via MII (Media Independent Interface).

The 20-channel Ethernet functional slices (CH0-CH19) are connected to the TDM assembling section 401 and the TDM disassembling section 402, and are further connected to a SONET/SDH transmitting section (not shown) via the TDM assembling section 401 and a SONET/SDH receiving section (not shown) via the TDM disassembling section 402.

Each of the Ethernet functional slices (CH0-CH19) is provided with SMII (Serial MII) 403 for connecting to a corresponding Ethernet physical layer device. The SMII 403 receives serial data E_RxD from the corresponding Ethernet physical layer device and converts it to parallel data, which is outputted to a FIFO buffer 404. Conversely, the SMII 403 receives parallel data from a FIFO buffer 405 and converts it to serial data, which is transferred as E_TxD to a corresponding Ethernet physical device. A link control section 406 is connected to the SMII 403 and further to the TDM assembling section 401, the TDM disassembling section 402 and an MII management interface 407. All physical devices are controlled through the MII management interface 407. In addition, a sync generating section 408 generates a signal for synchronization of the SMII 403 performing communication in units of 10 bits.

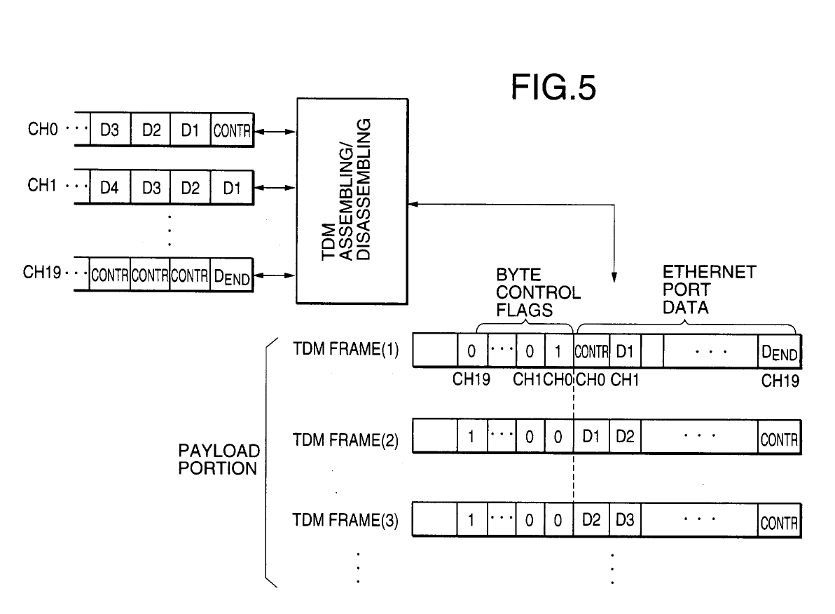

Hereinafter, concrete operations of the TDM assembling section 401 and the TDM disassembling section 402 will be described with reference to FIGS. 4 and 5.

(TDM Assembling Operation)

FIG. 5 is a schematic diagram for specifically explaining assembling/disassembling operations of a time-division multiplexing method according to the present invention. Here, it is assumed that serial data are input from the Ethernet physical layer devices of channels CH0-CH19 to the Ethernet functional slices, respectively.

First, the TDM assembling section 401 reads the 1st byte of each channel from the FIFO buffer 404 to produce a TDM frame (1). More specifically, since the 1st byte of the channel CHO is control data (Contr), the byte control flag of CHO is set to invalid “1” and the control data is written onto a position corresponding to the channel CHO of the Ethernet port data. Since the 1st byte of the channel CH1 is communication data (D1), the byte control flag of CH1 is set to valid “0” and the communication data D1 is written onto a position corresponding to the channel CH1 of the Ethernet port data. Similarly, data of the channels CH2-CH19 are written to produce the TDM frame (1).

Subsequently, the TDM assembling section 401 reads the 2nd byte of each channel from the FIFO buffer 404 to produce a TDM frame (2). More specifically, since the 2nd byte of the channel CHO is communication data (D1), the byte control flag of CHO is set to valid “0” and the communication data D1 is written onto a position corresponding to the channel CHO of the Ethernet port data. Since the 2nd byte of the channel CH1 is communication data (D2), the byte control flag of CH1 is set to valid “0” and the communication data D2 is written onto a position corresponding to the channel CH1 of the Ethernet port data. Similarly, data of the channels CH2-CH19 are written to produce the TDM frame (2).

The 24-byte TDM frames (1), (2), . . . , that are produced like this, are multiplexed into the payload as shown in FIG. 2 and are transmitted as an STM-16 frame from the SONET/SDH transmitting section.

(TDM Disassembling Operation)

It is assumed that serial the STM-16 frame is received from the SONET/SDH receiving section and each 24-byte TDM frame as shown in FIG. 5 is sequentially read out from the payload thereof.

First, the TDM disassembling section 402 determines from the 20-bit byte control flags of the TDM frame (1) whether the following Ethernet port data each are communication data or control data. Here, since the byte control flag of the channel CHO is “1”, it is determined to be control data and thereby the 1-byte Ethernet port data at the position corresponding to the channel CHO is read as control data. Further, since the byte control flag of the channel CH1 is also “0”, it is determined to be communication data and thereby the 1-byte Ethernet port data at the position corresponding to the channel CHi is read as communication data. Similarly, the first byte of the Ethernet port data for each channel is demultiplexed and read.

Subsequently, the TDM disassembling section 402 determines from the 20-bit byte control flags of the TDM frame (2) whether the following Ethernet port data each are communication data or control data. Here, since the byte control flag of the channel CHO is “0”, it is determined to be communication data and thereby the 1-byte Ethernet port data at the position corresponding to the channel CHO is read as communication data. Further, since the byte control flag of the channel CHi is also “0”, it is determined to be communication data and thereby the 1-byte Ethernet port data at the position corresponding to the channel CHi is read as communication data. Similarly, the second byte of the Ethernet port data for each channel is demultiplexed and read.

In this manner, the 20-channel Ethernet signals are demultiplexed from the TDM frames (1), (2), . . . , of the payload to be sequentially stored into the FIFO buffer 405, and they are outputted as serial data E_TxD to a corresponding Ethernet physical layer device through the SMII 403.

In the TDM assembling/disassembling apparatus as shown in FIG. 4, the control data as shown in FIG. 3(C) is generated by the combined use of line status information on the SMII 403 and information from the MII management interface 407. The line status information on the SMII 403 is “link status”, “line speed” and “duplex mode” recognized when frame data is invalid, and “PAUSE ability” is read through the MII management interface 407. Further, “presence or absence of collision detection” is determined by the SMII 403 within an Ethernet functional slice.

The time-division multiplexing transmission apparatus as shown in FIG. 4 can be formed as a chip set. Although the 20-channel Ethernet functional slices (CH0-CH19), the TDM assembling section 401 and the TDM disassembling section 402 can be implemented in hardware, the similar function can be also implemented in software as a computer system by running programs on a program-controlled processor such as a CPU. Such programs may be configured by using an appropriate program language so as to perform the above-mentioned TDM assembling and disassembling operations. Further, such programs may be stored on a recording medium in a variety of forms readable by a computer. It is also possible to transmit such programs through communication line.

As described above, according to the present invention, multiple transmission signals are sequentially read in units of a data block having a predetermined length, which is either communication data or control data, to produce TDM frames, each

1. An apparatus for time-division multiplexing (TDM) of multi-channel transmission signals into a frame of a digital synchronous network for transport, each of the multi-channel transmission signals including communication data and control data, characterized by:
TDM frame generating means for sequentially generating a plurality of TDM frames by sequentially reading a transmission signal for each of a plurality of channels in units of a data block having a predetermined length, the data block being one of the communication data and the control data, to contain one data block for each channel in a TDM frame; and
synchronous network frame generating means for generating the frame of the digital synchronous network by containing the plurality of TDM frames in a payload thereof.

2. An Ethernet signal time-division multiplexing and transport apparatus for time-division multiplexing (TDM) of a plurality of Ethernet signals, characterized by:
multi-channel physical layer devices each connected to a plurality of Ethernets;
TDM assembling means for sequentially generating a TDM frame by inputting each of multi-channel signals in units of a byte to contain a plurality of TDM frames in a payload portion of a frame of a digital synchronous network; and
synchronous transmitting means for transmitting the frame of the digital synchronous network to the synchronous network, the frame containing the TDM frames with an overhead portion added to the payload portion.

3. The Ethernet signal time-division multiplexing and transport apparatus according to claim 2, characterized in that each of the multi-channel signals includes Ethernet communication data and line control data, wherein the byte included in each TDM frame is one of the communication data and the control data.

4. The Ethernet signal time-division multiplexing and transport apparatus according to claim 3, characterized in that the TDM frame has a control flag for each of a plurality of channels, wherein each control flag indicates which one of communication data and control data the byte of a corresponding channel signal is.

5. The Ethernet signal time-division multiplexing and transport apparatus according to claim 2, further characterized by:
synchronous network receiving means for receiving the frame of the digital synchronous network; and
TDM disassembling means for separating multi-channel signals from the plurality of TDM frames contained in the payload portion of the received frame.

6. A system for transporting a plurality of Ethernet signals through a digital synchronous network, characterized in that
a transmitting side comprises:
a plurality of first physical layer devices each connected to a plurality of Ethernets;
TDM assembling means for sequentially generating a TDM frame by inputting data from each of the plurality of first physical layer devices in units of a byte to contain a plurality of TDM frames in a payload portion of a frame of a digital synchronous network; and
synchronous transmitting means for transmitting the frame of the digital synchronous network to the synchronous network, the frame containing the TDM frames with an overhead portion added to the payload portion, and
a receiving side comprises:
synchronous network receiving means for receiving the frame of the digital synchronous network;
TDM disassembling means for separating a plurality of Ethernet data from the plurality of TDM frames contained in the payload portion of the received frame; and
second physical layer devices for sending the plurality of Ethernet data to corresponding Ethernets, respectively.

7. A time-division multiplexing and transport method for time-division multiplexing (TDM) of multi-channel transmission signals into a frame of a digital synchronous network for transport, each of the multi-channel transmission signals including communication data and control data, characterized by the steps of:
sequentially reading a transmission signal for each of a plurality of channels in units of a data block having a predetermined length, the data block being one of the communication data and the control data;
generating a TDM frame containing one data block for each of the plurality of channels; and
generating the frame of the digital synchronous network by containing the plurality of TDM frames in a payload thereof, to transmit the frame.

8. The time-division multiplexing and transport method according to claim 7, characterized in that each byte of a signal included in the TDM frame is one of the communication data and the control data.

9. The time-division multiplexing and transport method according to claim 7, characterized in that the TDM frame has a control flag for each of the plurality of channels, wherein each control flag indicates which one of communication data and control data the data byte of a corresponding channel is.

10. A time-division multiplexing and transport program for instructing a computer to perform time-division multiplexing (TDM) of multi-channel transmission signals into a frame of a digital synchronous network for transport, each of the multi-channel transmission signals including communication data and control data, the program characterized by the steps of:
sequentially reading a transmission signal for each of a plurality of channels in units of a data block having a predetermined length, the data block being one of the communication data and the control data;
sequentially generating a TDM frame containing one data block for each of the plurality of channels; and
generating the frame of the digital synchronous network by containing the plurality of TDM frames in a payload portion thereof.

11. A time-division multiplexing and transport program for instructing a computer to perform time-division multiplexing (TDM) of multi-channel transmission signals into a frame of a digital synchronous network for transport, each of the multi-channel transmission signals including communication data and control data, the program characterized by the steps of:
sequentially generating a TDM frame by inputting each of multi-channel signals in units of a byte;
containing a plurality of TDM frames in a payload portion of a frame of a digital synchronous network;
adding an overhead portion to the payload portion of the frame containing the TDM frames; and
transmitting the frame of the digital synchronous network to the synchronous network.

12. A computer system performing the time-division multiplexing and transport based on the time-division multiplexing and transport program according to claim 10 or 11.

13. A recording medium storing a time-division multiplexing and transport program for instructing a computer to perform time-division multiplexing (TDM) of multi-channel transmission signals into a frame of a digital synchronous network for transport, each of the multi-channel transmission signals including-communication data and control data, the program characterized by the steps of:
sequentially reading a transmission signal for each of a plurality of channels in units of a data block having a predetermined length, the data block being one of the communication data and the control data;
sequentially generating a TDM frame containing one data block for each of the plurality of channels; and
generating the frame of the digital synchronous network by containing the plurality of TDM frames in a payload portion thereof.
